(19) United States
(12) Patent Application Publication
(10) Pub. No.: US 2008/0052619 A1
(43) Pub. Date: Feb. 28, 2008

(54) Spell Checking Documents with Marked Data Blocks

(76) Inventor: Jason J. Illg, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/466,951

(22) Filed: Aug. 24, 2006

(51) Int. Cl. G06F 17/00

(52) U.S. Cl. 715/257; 715/256; 715/272

(57) ABSTRACT

In an embodiment, a subset of a document that includes data blocks is marked by begin ignore tags and end ignore tags. A subsequent spell check operation checks the spelling accuracy of a complement of the subset and ignores the spelling accuracy of the subset. In an embodiment, the data blocks are copied from selected origin locations in the document or another document to a buffer and then pasted from the buffer to the document. The data blocks are then marked to be ignored in response to an ignore spell check option associated with a paste command. In another embodiments, the data blocks are selected and marked in response to an ignore option associated with an edit command. In this way, spell checking of subsets of a document may be selectively enabled and disabled.

### FIELD

An embodiment of the invention generally relates to computer systems and more specifically relates to checking the spelling of documents with data blocks that are marked to be ignored.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

One use of computer systems is in the creation, modifying, and editing of documents via an editor. Examples of such documents include letters, emails, books, articles, notes, and documentation. One common tool provided by editors is a spell checker, which compares words in the document to a dictionary of correctly spelled words. If the spell checker determines that a word is misspelled (because it is absent from the dictionary), the spell checker may identify the word as misspelled, provide a list of possible replacements for the misspelled word, change the misspelled word to a selected one of the possible replacements, or ignore the misspelled word, depending on user-selected options.

While spell checkers can be very helpful, they suffer from a problem that occurs when users collaborate on the creation and modification of documents. In one example of collaboration, multiple users may edit the same document, with each user being responsible for a block of data, such as a different section, chapter, page, paragraph, or sentence. Another example of collaboration occurs when users send each other email. One user may create some information in a email and distribute it to others, who in turn reply or forward the received email, adding their own information while retaining or embedding the received information created by others. This process of forwarding and/or replying while adding information may continue indefinitely, and emails often contain a long string of embedded previously sent, forwarded, and/or replied-to emails. While users want their own information to be correct, which includes correct spelling, they do not necessarily want to edit or verify the accuracy or correctness of the information supplied by others, which takes additional time and may require knowledge regarding the intent of the originator of the information.

A similar problem occurs when a user pastes technical data into a document and then checks the spelling of the document, even though the technical data, or portions thereof, were not intended to be words found in a dictionary. Technical data may include variable names from program source code, database field names, or information with acronyms or abbreviations that are not intended to be correctly spelled words. For example, a database might have the field names “fname,” “lname,” or “phnum,” which are recognizable to the reader as representing a first name, last name, and phone number, but a spell checker will individually report them as spelling errors, forcing the user to manually reply to multiple, individual reports of spelling errors, which is tedious and time consuming.

Thus, a better technique is needed for handling the spell checking of documents.

### SUMMARY

A method, apparatus, system, and signal-bearing medium are provided. In an embodiment, a subset of a document that includes data blocks is marked by begin ignore tags and end ignore tags. A subsequent spell check operation checks the spelling accuracy of a complement of the subset and ignores the spelling accuracy of the subset. In an embodiment, the data blocks are copied from selected origin locations in the document or another document to a buffer and then pasted from the buffer to the document. The data blocks are then marked to be ignored in response to an ignore spell check option associated with a paste command. In another embodiments, the data blocks are selected and marked in response to an ignore option associated with an edit command. In this way, spell checking of subsets of a document may be selectively enabled and disabled.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example editor user interface with paste options, according to an embodiment of the invention.

FIG. 3 depicts a block diagram of an example editor user interface with edit options, according to an embodiment of the invention.

FIG. 4 depicts a block diagram of an example document, according to an embodiment of the invention.

FIG. 5 depicts a flowchart for processing open, copy, paste, and paste option commands, according to an embodiment of the invention.

FIG. 6 depicts a flowchart for processing spell check and close commands, according to an embodiment of the invention.

FIG. 7 depicts a flowchart for processing edit commands, according to an embodiment of the invention.

FIG. 8 depicts a flowchart for processing a spell check operation, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

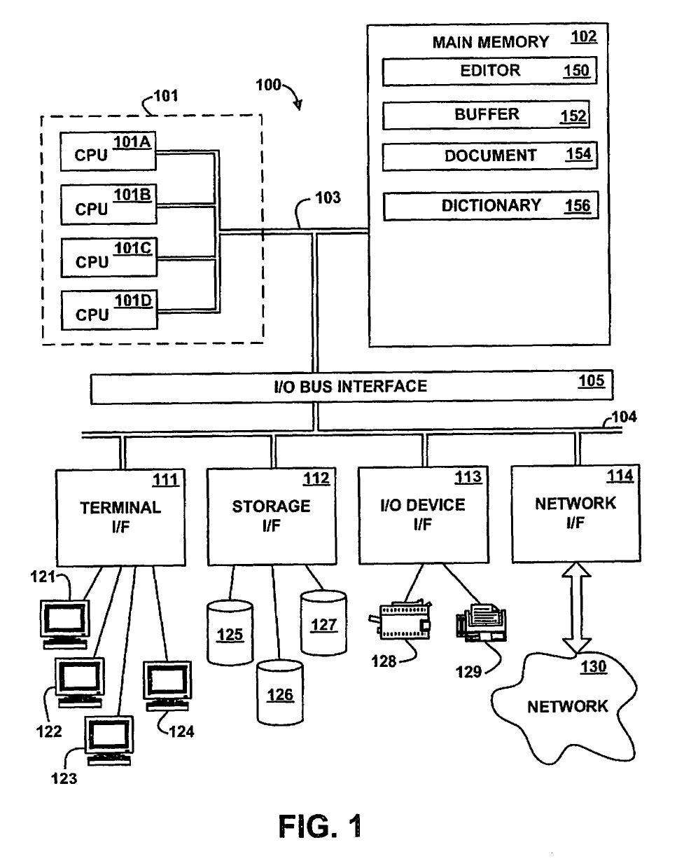

Referring to the Drawings, wherein like numbers denote like parts throughout the several views, FIG. 1 depicts a high-level block diagram representation of a computer system 100 connected to a network 130, according to an embodiment of the present invention. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes an editor 150, a buffer 152, a document 154, and a dictionary 156. Although the editor 150, the buffer 152, the document 154, and the dictionary 156 are illustrated as being contained within the main memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the editor 150, the buffer 152, the document 154, and the dictionary 156 are illustrated as being contained within the main memory 102, these elements are not necessarily all completely contained in the same storage device at the same time. Further, although the editor 150, the buffer 152, the document 154, and the dictionary 156 are illustrated as being separate entities, in other embodiments some of them, or portions of some of them, may be packaged together.

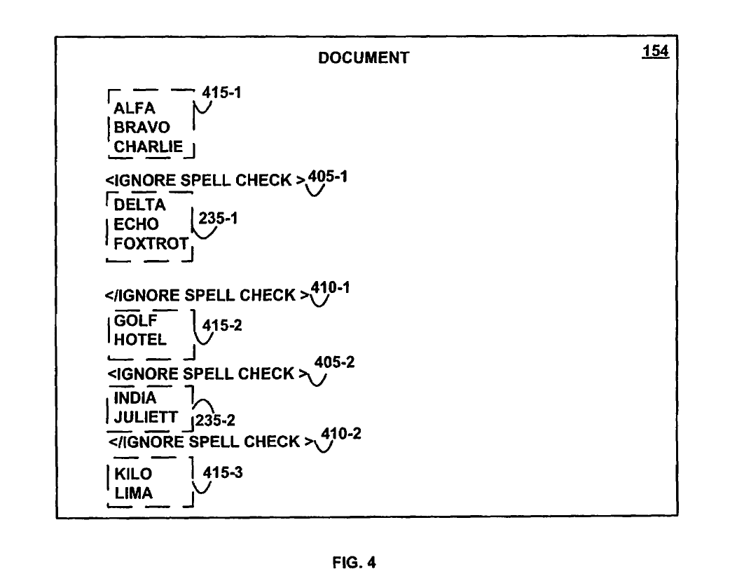

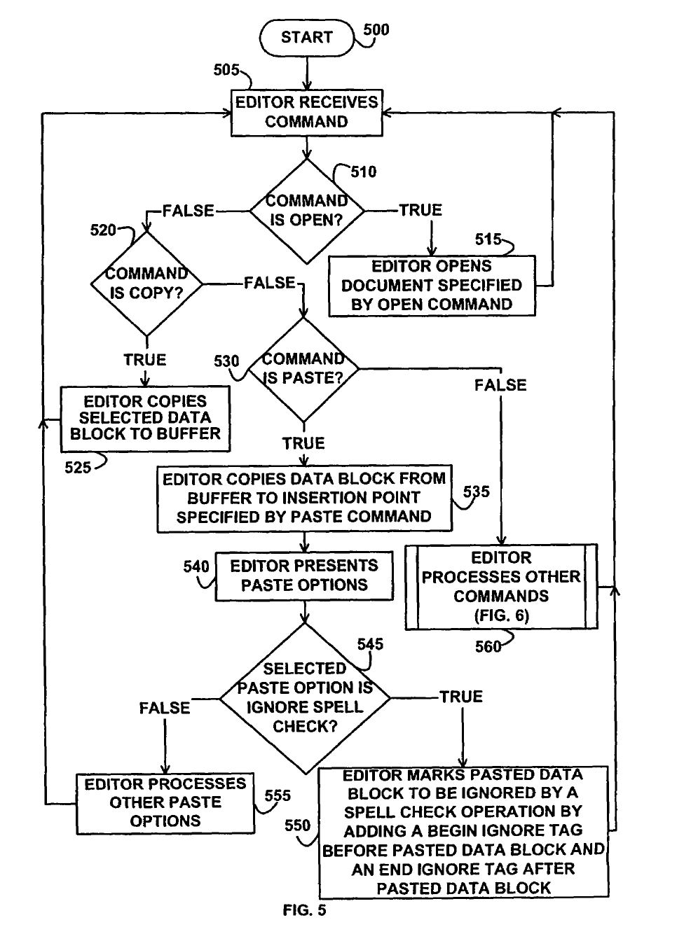

The editor 150 may edit, open, and/or close the documents 154. The editor 150 may further check the spelling of the documents 154 via the dictionary 156, which may include a list of correctly spelled words. The editor 150 may further copy, cut, and paste data blocks either within the same document 154 or between different documents 154, using the buffer 152 as an intermediary. In an embodiment, the editor 150 includes instructions capable of executing on the processor 101 or statements capable of being interpreted by instructions executing on the processor 101 to perform the functions as further described below with reference to FIGS. 5, 6, 7, and 8. In another embodiment, the editor 150 may be implemented in microcode. In another embodiment, the editor 150 may be implemented in hardware via logic gates and/or other appropriate hardware techniques. In an embodiment, the document 154 may be an email, a web page, a word processing document, a file, or a database, and may include words, control or formatting tags or codes, video, images, or any portion, combination. or multiple thereof. Words are sequences of one or more characters separated by spaces. Words may be correctly spelled (present in the dictionary 156) or incorrectly spelled (not present in the dictionary 156). An example of the document 154 is further described below with reference to FIG. 4.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

It should be understood that FIG. 1 is intended to depict the representative major components of the computer system 100 and the network 130 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media that may be operatively or communicatively connected (directly or indirectly) to the processor 101. The signal-bearing media may include, but are not limited to:

(1) information permanently stored or encoded on a non-rewriteable storage medium that is computer readable, e.g., a read-only memory device attached to or within a computer system, such as a CD-ROM readable by a CD-ROM drive;

(2) alterable information stored or encoded on a rewriteable storage medium that is computer readable, e.g., a hard disk drive (e.g., DASD 125, 126, or 127), the memory 102, CD-RW, or diskette; or

(3) information conveyed to the computer system 100 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

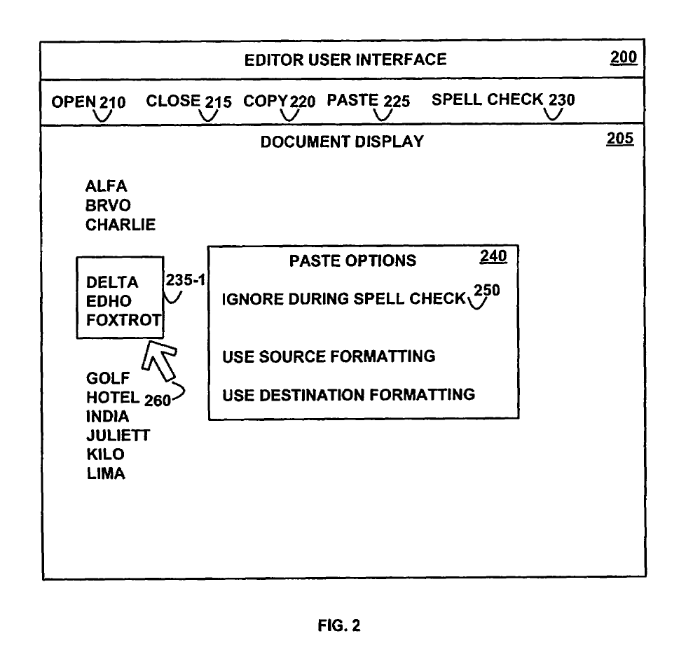

FIG. 2 depicts a block diagram of an example editor user interface 200 that includes paste options, according to an embodiment of the invention. The editor 150 may present or display the user interface 200 via the terminals 121, 122, 123, or 124. The user interface 200 includes a document display 205, which is visual rendering of the document 154 on a display screen or video terminal. The editor 150 renders the document 154 for display in the document display 205 by interpreting control tags or codes in the document 154 in order to format the data (e.g., words, lines, symbols, video, or images) of the document 154.

The user interface 200 includes an open command 210, a close command 215, a copy command 220, a paste command 225, and a spell check command 230. In response to selection (e.g., via a keyboard, mouse, or other pointing device) of the command 210, 215, 220, 225, or 230, the user interface 200 sends the selected command to the editor 150, which processes the command. For example, selection of the open command 210 requests the editor 150 to open a document 154 and to render and display the opened document 154 as the document display 205. Selection of the close command 215 requests the editor 150 to close a document 154 and cease displaying the closed document 154 in the document display 205.

Selection of the copy command 220 requests the editor 150 to copy or cut a selected data block 235-1 from a selected origin location (e.g., selected by operation of a pointer 260 or cursor controlled by a keyboard or pointing device) in the document 154 to the buffer 152. In a copy operation, the editor 150 creates a copy of the selected data block 235-1 and adds the copy to the buffer 152. In a cut operation, the editor 150 moves the selected data block 235-1 from the selected origin location to the buffer 152, so that after the cut operation, the selected data block 235-1 is no longer present in the document 154.

Selection of the paste command 225 requests the editor 150 to paste (copy) the contents of the buffer 152 (e.g., the data block 235-1 that was previously copied to the buffer 152) to a selected destination location (e.g., selected by operation of the pointer 260). In various embodiments, the selected destination location may be within the same document 154 as the selected origin location or may be in a different document 154 from the selected origin location. That is, the editor 150 may use the buffer 152 to copy and paste the selected data block 235-1 within the same document 154 or between different documents 154, wherein the buffer 152 is an intermediary storage location. The paste command 225 may further have associated paste options 240, one of which is an ignore during spell check paste option 250. The editor 150 may display the paste options 240 in response to receiving the paste command 225, either before or after pasting the data block 235-1 from the buffer 152 to the selected destination location in the document 154. If the user selects the ignore during spell check option 250 of the paste options 240, in response to receiving the ignore during spell check option 250 of the paste options 240, the editor 150 marks the pasted data block 235-1 with ignore tags, which causes the editor 150 to ignore or skip past the pasted data block 235-1 during a subsequent spell check operation (requested via the spell check command 230).

Selection of the spell check command 230 requests the editor 150 to check or verify the accuracy of the spelling of some or all of the words in the document 154. The editor 150 ignores, during the spell check operation, the data block or blocks that are marked with ignore tags. Stated another way, the spell check command 230 requests the editor 150 to check the spelling of the complement of a subset of the document 154, where the subset includes one or more marked data blocks, such as the data block 235-1. The data block 235-1 includes one or more words, which the editor 150 is capable of comparing to the words in the dictionary 156 as part of a spell check operation.

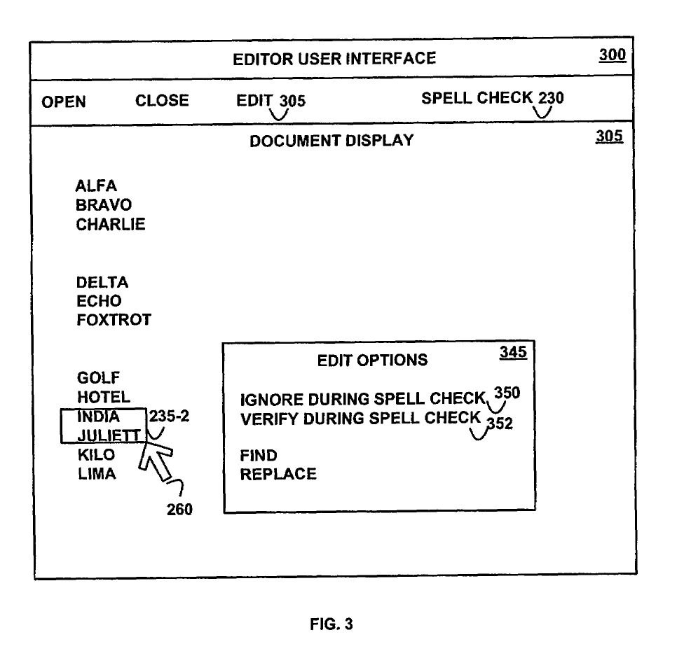

FIG. 3 depicts a block diagram of an example editor user interface 300 that includes edit options, according to an embodiment of the invention. The editor 150 may present or display the user interface 300 via the terminals 121, 122, 123, or 124.

The user interface 300 includes a document display 305, which is visual rendering of the document 154 on a display screen or video terminal. The editor 150 renders the document 154 for display in the document display 305 by interpreting control tags or codes in the document 154 in order to format the data (e.g., words, lines, symbols, video, or images) of the document 154.

The user interface 300 includes an edit command 305 and a spell check command 230. In response to selection (e.g., via a keyboard, mouse, or other pointing device) of the command 305 or 230, the user interface 300 sends the selected command to the editor 150, which processes the command. For example, selection of the edit command 305 requests the editor 150 to display the edit options 345, and selection of the spell check command 230 requests the editor 150 to verify the spelling of the words in the document 154.

The edit options 345 includes an ignore during spell check option 350 and a verify during spell check option 352. If the user selects the data block 235-2 and selects the ignore during spell check option 350, in response the selection of the data block 235-2 and receiving the ignore during spell check option 350, the editor 150 marks the selected data block 235-2 with ignore tags, which causes the editor 150 to ignore or skip past the selected data block 235-2 during a subsequent spell check operation (requested via the spell check command 230). The user may select the selected data block 235-2 via operation of a mouse, other pointing device, or keyboard via manipulation of the pointer 260.

If the user selects the data block 235-2 and selects the verify during spell check option 352, in response the selection of the data block 235-2 and receiving the verify during spell check option 352, the editor 150 removes the ignore tags from the selected data block 235-2 if they are present, regardless of whether the ignore tags are present as a result of the ignore option 350 or the ignore option 250 (FIG. 2).

FIG. 4 depicts a block diagram of an example document 154, according to an embodiment of the invention. The example document 154 includes a data block 235-1, which is delimited by a begin ignore spell check tag 405-1 prior to the data block 235-1 and an end ignore spell check tag 410-1 after the data block 235-1. The editor 150 saved the tags 405-1 and 410-1 in the document 154 in response to the ignore during spell check paste option 250 of the paste options 240. The example document 154 further includes a data block 235-2, which is delimited by a begin ignore spell check tag 405-2 prior to the data block 235-2 and an end ignore spell check tag 410-2 after the data block 235-2. The editor 150 saved the tags 405-2 and 410-2 in the document 154 in response to the ignore during spell check edit option 350 of the edit options 345. The data block 235-1 is marked by its tags 405-1 and 410-1, and the data bock 235-2 is marked by its tags 405-2 and 410-2.

Control tags in the document 154, such as the tags 405-1, 405-2, 410-1, and 410-2 are also known as control codes. The editor 150 creates the document display (205 of FIG. 2 or 305 of FIG. 3) by formatting, rendering, or processing the data (the words, lines, symbols, graphics, images, or video) in the document 154 based on the instructions in the control tags or codes. The control tags or codes are not displayed in the document displays 205 and 305 because they specify how the document displays 205 and 305 are formatted or how the data in the document 154 is processed. In another embodiment, the editor 150 may provide a display mode or view option in the user interface 200 or 300 in which the control tags are displayed in the document display 205 or 305.

Together, the data blocks 235-1 and 235-2 form a subset of the words in the document 154 that the editor 150 skips past or ignores during a spell check operation. Thus, the editor 150 does not check or verify the accuracy of the spelling of the words in the marked subset formed by the data blocks 235-1 and 235-2. But, the editor 150 does check or verify the spelling of the words in the document 154 that form the complement of the marked subset. The complement is formed by the data blocks 415-1, 415-2, and 415-3, i.e., all of the words in the document 154 that are not part of the marked subset (the union of the data blocks 235-1 ad 235-2).

A set is a collection of distinct objects considered as a whole. The objects of a set are called elements or members. With respect to the document 154 of FIG. 4, all of the words in the document 154 together comprise the set, and the elements are words that the editor 150 can either spell check, e.g., by comparing the words to correctly-spelled words in the dictionary 156, or ignore. Note that in the set theory of mathematics, a set does not contain multiple copies of the same element; in contrast, the document 154 may contain multiple copies of the same word. But, as used herein, every word in the document 154 has a unique position or location within the document 154, so by interpreting an element as a word in combination with its location, the document 154 meets the definition of a set.

If every member of a hypothetical set A is also a member of a hypothetical set B, then A is said to be a subset of B. For example, both the data blocks 235-1 and 235-2 are subsets of the words in the document 154. Sets or subsets may be added together to form a “union.” Thus, the union of A and B, denoted by A U B, is the set of all things which are members of either A or B. Using the example of FIG. 4, the union of the data blocks 235-1 and 235-2 is a subset of the words in the document 154 and includes all of the data blocks that are marked to be ignored by a spell check operation. Two sets can also be “subtracted” to form a complement. The complement of A in B (also called the set theoretical difference of B and A), denoted by B−A, (or B\A) is the set of all elements which are members of B, but not members of A. If A is a subset of B, the complement of A is denoted as A′, and A U A′=B. Using the example of FIG. 4, the complement of the subset of the words in the document 154 that are marked to be ignored by a spell check operation is the subset that is not marked and will have its spelling checked. Thus, the marked subset is the union of data blocks 235-1 and 235-2, and the complement of the marked subset is the union of the unmarked data blocks 415-1, 415-2, and 415-3.

FIG. 5 depicts a flowchart for processing open, copy, paste, and paste option commands, according to an embodiment of the invention. Control begins at block 500. Control then continues to block 505 where the editor 150 receives a command from the editor user interface 200 or 300 (FIGS. 2 or 3). Control then continues to block 510 where the editor 150 determines whether the received command is an open document command 210. If the determination at block 510 is true, then the editor 150 opens the document 154 specified by the open document command 210, renders the document 154 via any embedded control tags or codes, and displays the opened document 154, or a portion of the opened document 154, e.g., via the document display 205 or 305, on a display terminal 121, 122, 123, or 124. Control then returns to block 505 where the editor 150 receives the next command, as previously described above.

If the determination at block 510 is false, then the received command is not an open document command 210, so control continues to block 520 where the editor 150 determines whether the received command is a copy command 220. If the determination at block 520 is true, then the received command is a copy command 220, so control continues to block 525 where the editor 150 receives a selection of a data block at an origin location and copies the selected data block from the origin location in the document 154 to the buffer 152. In an embodiment, the editor 150 copies any selected control tags, such as the begin ignore spell check and the end ignore spell check tags with the selected data block to the buffer. In another embodiment, the editor 150 does not copy the begin ignore spell check and the end ignore spell check tags. Control then returns to block 505 where the editor 150 receives the next command, as previously described above.

If the determination at block 520 is false, then the received command is not a copy command 220, so control continues to block 530 where the editor 150 determines whether the received command is a paste command 225. If the determination at block 530 is true, then the received command is a paste command 225, so control continues to block 535 where the editor 150 receives a selected destination location associated with the paste command 225 and pastes (copies) the data block already present in the buffer 152 from the buffer 152 to the selected destination location. In an embodiment, the editor 150 also pastes any begin ignore spell check and end ignore spell check tags that are included with or embedded in the data block to the selected destination location. In another embodiment, the editor 150 does not paste (copy) any begin ignore spell check and end ignore spell check tags that are included with or embedded in the data block to the selected destination location. Control then continues to bock 540 where the editor 150 optionally presents the paste options 240 via the user interface 200. Control then continues to block 545 where the editor 150 determines whether a received paste option selected via the user interface 200 is the ignore during spell check option 250.

If the determination at block 545 is true, then the received paste option selected via the user interface 200 is the ignore during spell check option 250, so control continues to block 550 where the editor 150 marks the pasted data block (e.g., the data block 235-1) to be ignored by the spell check operation by adding the begin ignore tag before the selected data block and adding the end ignore tag after the selected data block at the destination location if not already present. The editor 150 saves the begin ignore tag and the end ignore tag to the document 154. Control then returns to block 505 where the editor 150 receives the next command, as previously described above.

If the determination at block 545 is false, then the received paste option selected via the user interface 200 is not the ignore during spell check option 250, so control continues to block 555 where the editor 150 processes another option of the paste options 240. Control then returns to block 505 where the editor 150 receives the next command, as previously described above.

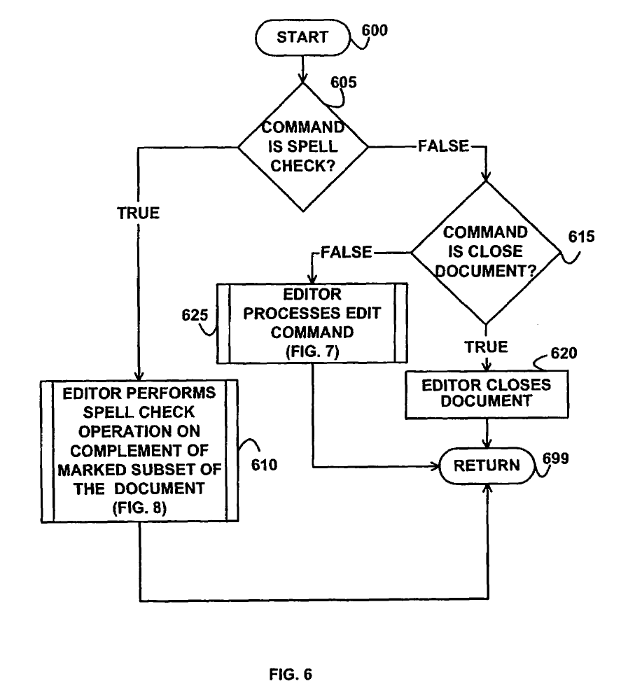

If the determination at block 530 is false, then the received command is not a paste command 225, so control continues to block 560 where the editor 150 processes other commands, as further described below with reference to FIG. 6. Control then returns to block 505 where the editor 150 receives the next command, as previously described above.

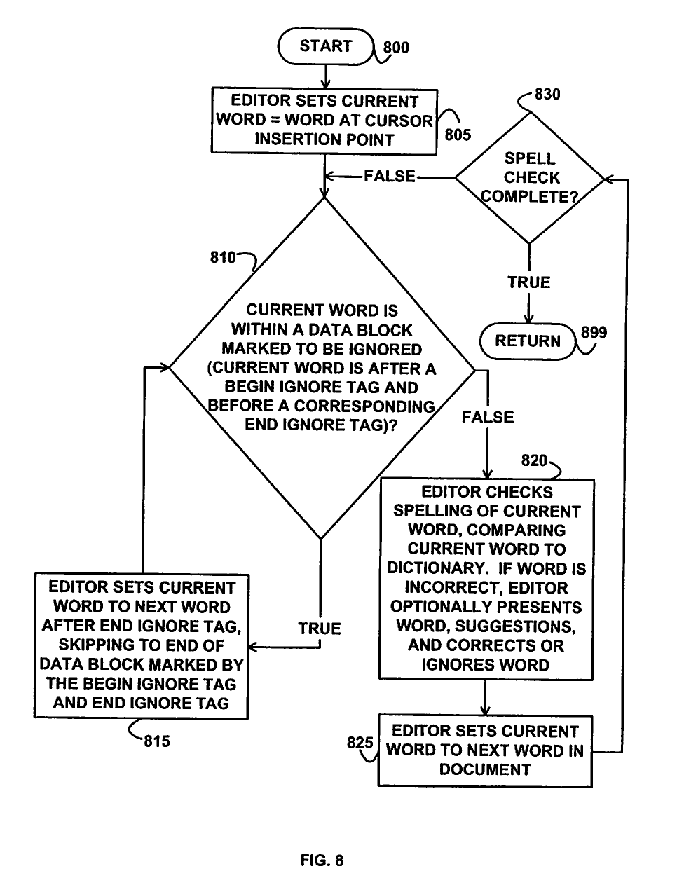

FIG. 6 depicts a flowchart for processing spell check and close commands, according to an embodiment of the invention. Control begins at block 600. Control then continues to block 605 where the editor 150 determines whether the received command is a spell check command 230. If the determination at block 605 is true, then the received command is a spell check command 230, so control continues to block 610 where the editor 150 performs a spell check operation on the complement of the marked subset of the document 154, as further described below with reference to FIG. 8. In an embodiment, the spell check operation is separate from the marking of the subset. That is, the marking of the subset occurs prior to the spell check operation, is not part of the processing of the spell check operation, and does not occur in response to the spell check operation finding incorrectly spelled words. Control then continues to block 699 where the logic of FIG. 6 returns.

If the determination at block 605 is false, then the received command is not a spell check command 230, so control continues to block 615 where the editor 150 determines whether the received command is a close document command 215. If the determination at block 615 is true, then the received command is a close document command 215, so control continues to block 620 where the editor 150 closes the specified document 154. The closed document 154 includes the begin ignore tags and the end ignore tags that were previously saved to the document 154, so that the next time the editor 150 opens the document 154, the begin ignore tags and the end ignore tags are present, and they mark the data block to be ignored by a subsequent spell check operation. Control then continues to block 699 where the logic of FIG. 6 returns.

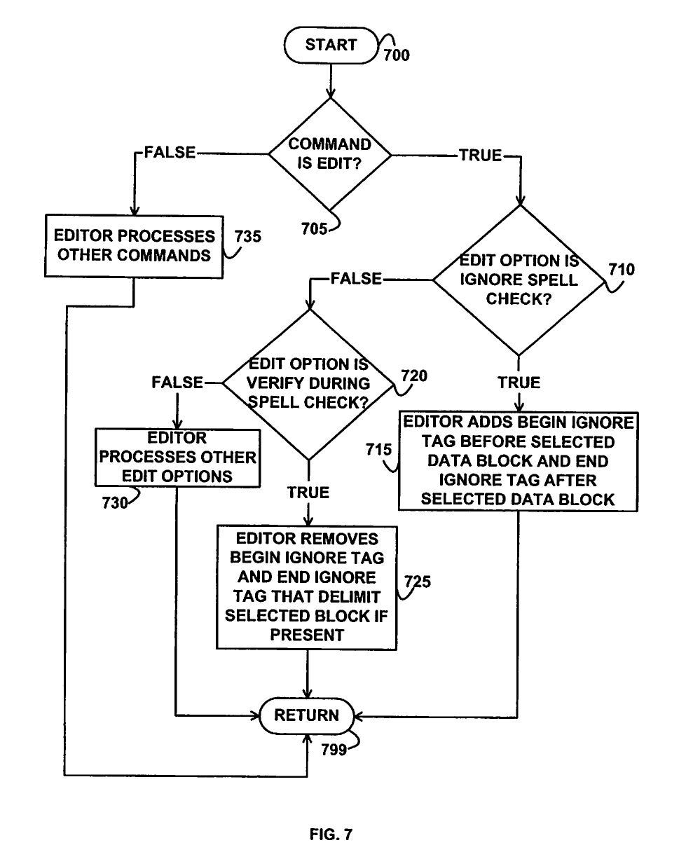

If the determination at block 615 is false, then the received command is not a close document command 215, so control continues to block 625 where the editor 150 processes edit commands, as further described below with reference to FIG. 7. Control then continues to block 699 where the logic of FIG. 6 returns.

FIG. 7 depicts a flowchart for processing edit commands, according to an embodiment of the invention. Control begins at block 700. Control then continues to block 705 where the editor 150 determines whether the received command is an edit command 305. If the determination at block 705 is true, then the received command is an edit command 305, so control continues to block 710 where the editor 150 determines whether the edit command 305 includes an edit option 345 that specifies a selected data block in the document 154 is to be ignored by subsequent spell check operation (the ignore during spell check option 350). If the determination at block 710 is true, then the edit command 305 includes an edit option 345 that specifies a selected data block in the data is to be ignored by a subsequent spell check operation, so control continues to block 715 where the editor 150 receives a selection of a data block and marks the selected data block to be ignored by a subsequent spell check operation by adding a begin ignore tag before the selected data block and an end ignore tag after the selected data block. Control then continues to block 799 where the logic of FIG. 7 returns.

If the determination at block 710 is false, then the edit command 305 does not include an edit option that specifies a selected data block in the data is to be ignored by subsequent spell check operation, so control continues to block 720 where the editor 150 determines whether the edit option is the verify during spell check option 352. If the determination at block 720 is true, then the edit option is the verify during spell check option 352, so control continues to block 725 where the editor 150 receives a selection of the block and removes the begin ignore tag and the end ignore tag, if present, that delimit the selected block from the document 154. Control then continues to block 799 where the logic of FIG. 7 returns.

If the determination at block 720 is false, then the edit option is not the verify during spell check option 352, so control continues to block 730 where the editor processes other edit options. Control then continues to block 799 where the logic of FIG. 7 returns.

If the determination at block 705 is false, then the received command is not an edit command 305, so control continues to block 735 where the editor 150 processes other commands. Control then continues to block 799 where the logic of FIG. 7 returns.

FIG. 8 depicts a flowchart for processing for a spell check operation on a complement of a marked subset of the document 154, according to an embodiment of the invention. Control begins at block 800. Control then continues to block 805 where the editor 150 sets a current word in the document 154 to be a word at the insertion point associated with a cursor or pointer 260. Thus, the editor 150 starts the spell check processing at the location in the document 154 selected by a user via the pointer 260. In another embodiment, the editor 150 may start the spell check processing at the beginning of the document 154 or at any other appropriate location.

Control then continues to block 810 where the editor 150 determines whether the current word is after a begin ignore tag and before a corresponding end ignore tag within the document 154. That is, the editor 150 determines whether the current word is between corresponding begin and end ignore tags, meaning that the current word is within a data block that was previously marked by tags to be ignored (e.g., marked by the editor 150 in response to the ignore options 250 or 350) by the spell check operation.

If the determination of block 810 is true, then the current word is between corresponding begin and end ignore tags, so control continues to block 815 where the editor 150 sets the current word to be the next word after the end ignore tag, which skips the spell check operation past the data block that is marked to be ignored by the corresponding begin and end ignore tags. Control then returns to block 810 where the editor 150 makes the determination on the new current word, as previously described above.

If the determination at block 810 is false, then the current word is not between corresponding begin and end ignore tags, so the current word is part of a complement of the marked data blocks in the document 154, so control continues to block 820 where the editor 150 checks the spelling of the current word, by comparing the current word to the correctly spelled words in the dictionary 156. If the current word is not present in the dictionary 156, then the current word is incorrectly spelled, so the editor 150 optionally presents the current word, optionally suggests one or more correctly spelled words from the dictionary 156 as alternatives to the current word, optionally changes or replaces the current word with a selected correctly spelled word from the dictionary 156, optionally adds the current word to the dictionary 156, and/or ignores the current word. Control then continues to block 825 where the editor 150 sets the current word to be the next word in the document 154.

Control then continues to block 830 where the editor 150 determines whether the spell check operation is complete. In various embodiments, the spell check may be complete if editor 150 receives a request to terminate the spell check, if the current word has reached the end of the document 154, if all of the words in the complement of the marked data blocks have been checked by the iterative operation of block 820, or if the current word has reached the starting point of the spell check operation (e.g., the word at the cursor insertion point, as previously described above with reference to block 805).

If the determination of block 830 is true, then the spell check is complete, so control continues to block 899 where the logic of FIG. 8 returns.

If the determination of block 830 is false, then the spell check operation is not complete, so control returns to block 810 where the editor 150 makes the determination on the new current word, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
marking a subset of a document, wherein the document comprises a plurality of words; and
performing a spell check operation on the document after the marking, wherein the performing further comprises checking spelling accuracy of a complement of the subset in the plurality of words and ignoring the spelling accuracy of the subset, and wherein the performing the spell check operation is separate from the marking the subset.

2. The method of claim 1, wherein the marking further comprises:
pasting a data block from a buffer to the document, wherein the subset comprises the data block; and
marking the data block in the document in response to the pasting.

3. The method of claim 2, further comprising;
copying the data block from a selected origin location in the document to the buffer.

4. The method of claim 2, further comprising;
copying the data block from a selected origin location in another document to the buffer.

5. The method of claim 1, wherein the marking further comprises:
pasting the data block from a buffer to a destination location in the document, wherein the subset comprises the data block; and
marking the data block at the destination location point in the document if an ignore spell check option of a paste command is received, wherein the paste command requests the pasting.

6. The method of claim 1, wherein the marking further comprises inserting a begin ignore tag before a data block and an end ignore tag after the data block, wherein the subset comprises the data block.

7. The method of claim 1, wherein the marking further comprises:
marking a plurality of data blocks, wherein the subset comprises the plurality of data blocks, wherein the marking further comprises inserting a respective begin ignore tag before each of the plurality of data blocks and a respective end ignore tag after each of the plurality of data blocks.

8. The method of claim 1, wherein the marking further comprises marking the subset of a document in response to a selection of the subset and receipt of an ignore option that requests the subset to be ignored by the spell check operation.

9. The method of claim 6, wherein the performing the spell check operation further comprises:
reading a first word of the plurality of words from the document;
determining if the first word is between the begin ignore tag and the end ignore tag;
if the first word is between the begin ignore tag and the end ignore tag, skipping to a next word after the end ignore tag and comparing the next word to a dictionary of correctly spelled words; and
if the first word is not between the begin ignore tag and the end ignore tag, comparing the first word to a dictionary of correctly spelled words.

10. A signal-bearing medium comprising:
marking a subset of a document, wherein the document comprises a plurality of words, wherein the marking further comprises pasting a data block from a buffer to a destination location in the document and marking the data block at the destination location if an ignore spell check option associated with a paste command is received, wherein the paste command requests the pasting, and wherein the subset comprises the data block; and
performing a spell check operation on the document after the marking, wherein the performing further comprises checking spelling accuracy of a complement of the subset in the plurality of words and ignoring the spelling accuracy of the subset.

11. The signal-bearing medium of claim 10, wherein the marking further comprises inserting a begin ignore tag before a data block and an end ignore tag after the data block, wherein the subset comprises the data block.

12. The signal-bearing medium of claim 10, wherein the marking further comprises:
marking a plurality of the data blocks, wherein the subset comprises the plurality of the data blocks, wherein the marking further comprises inserting a respective begin ignore tag before each of the plurality of data blocks and a respective end ignore tag after each of the plurality of data blocks.

13. The signal-bearing medium of claim 11, wherein the performing the spell check operation further comprises:
reading a first word of the plurality of words from the document; and
determining if the first word is between the begin ignore tag and the end ignore tag.

14. The signal-bearing medium of claim 13, wherein the performing the spell check operation further comprises:
if the first word is between the begin ignore tag and the end ignore tag, skipping to a next word after the end ignore tag and comparing the next word to a dictionary of correctly spelled words.

15. The signal-bearing medium of claim 14, wherein the performing the spell check operation further comprises:
if the first word is not between the begin ignore tag and the end ignore tag, comparing the first word to a dictionary of correctly spelled words.

16. The signal-bearing medium of claim 11, where the marking the data block at the destination location if the ignore spell check option associated with a paste command is received further comprises:
displaying the ignore spell check option in response to the pasting; and
marking the data block if the ignore spell check option is selected.

17. A method for configuring a computer, comprising:
configuring the computer to mark a subset of a document, wherein the document comprises a plurality of words, wherein the configuring the computer to mark further comprises configuring the computer to paste a data block from a buffer to a destination location in the document, mark the data block at the destination location if an ignore spell check option associated with a paste command is received, and insert a begin ignore tag before a data block and an end ignore tag after the data block, wherein the paste command requests the paste, and wherein the subset comprises the data block; and
configuring the computer to perform a spell check operation on the document after the marking, wherein the performing further comprises checking spelling accuracy of a complement of the subset in the plurality of words and ignoring the spelling accuracy of the subset.

18. The method of claim 17, wherein the configuring the computer to mark further comprises:
configuring the computer to mark a plurality of the data blocks, wherein the subset comprises the plurality of the data blocks, wherein the marking further comprises inserting a respective begin ignore tag before each of the plurality of data blocks and a respective end ignore tag after each of the plurality of data blocks.

19. The method of claim 17, wherein the configuring the computer to perform the spell check operation further comprises:
configuring the computer to read a first word of the plurality of words from the document;
configuring the computer to determine if the first word is between the begin ignore tag and the end ignore tag;
configuring the computer to skip to a next word after the end ignore tag and compare the next word to a dictionary of correctly spelled words if the first word is between the begin ignore tag and the end ignore tag; and
configuring the computer to compare the first word to a dictionary of correctly spelled words if the first word is not between the begin ignore tag and the end ignore tag.

20. The method of claim 17, where the configuring the computer to mark the data block at the destination location if the ignore spell check option associated with a paste command is received further comprises:
configuring the computer to present the ignore spell check option in response to the pasting; and
configuring the computer to mark the data block if the ignore spell check option is selected.
